(19) United States
(12) Patent Application Publication
(10) Pub. No.: US 2019/0071325 A1
(43) Pub. Date: Mar. 7, 2019

(54) COMPOSITIONS FOR WATER TREATMENT

(71) Applicant: METOXS PTE. LTD., SINGAPORE (SG)

(72) Inventor: Abraham Fouad Jalbout, Tucson, AZ (US)

(21) Appl. No.: 16/070,463

(22) PCT Filed: Jan. 12, 2017
(86) PCT No.: PCT/IB2017/050169

§ 371 Date: Jul. 16, 2018

Related U.S. Application Data
(60) Provisional application No. 62/287,444, filed on Jan. 27, 2016.
(60) Provisional application No. 62/278,987, filed on Jan. 15, 2016.

(51) Int. Cl. C02F 1/28; B01J 20/02; B01J 20/18; B01J 20/20; B01J 20/28; B01J 20/30

(52) U.S. Cl. CPC C02F 1/281; B01J 20/0248; B01J 20/18; C02F 2101/20; B01J 20/28052; B01J 20/3021; B01J 20/20

(57) ABSTRACT

Graphite oxide, graphene oxide and/or graphene-containing composites for use in a filter assemblies and methods of making the same are described. Fluid treatment systems using a filter assembly having graphite oxide, graphene oxide and/or graphene-containing composites are also described. The filter assemblies and systems described herein can be used to purify contaminated fluids including water, aqueous solutions, a gas or mixture of gases, or any combination thereof. The graphite oxide, graphene oxide and/or graphene-containing composites can also have one or more of a zeolite, a boron nitride, a rare earth element, and an ionic salt incorporated therein for specific uses and desired properties.

### CROSS-REFERENCE TO RELATED APPLICATIONS

This application claims the benefit of U.S. provisional application No. 62/278,987, filed Jan. 15, 2016 and U.S. provisional application No. 62/287,444, filed Jan. 27, 2016, the contents of which are incorporated by reference herein in its entirety.

### FIELD OF THE INVENTION

The present invention relates to compositions for the treatment and purification of contaminated fluids such as water, air, or gas mixtures. The present invention further relates to systems incorporating water and air treatment and purification compositions.

### BACKGROUND OF THE INVENTION

Contamination of potable water and inadequate access to purified potable water fit for human consumption is an alarming issue across the world. Contamination of potable water with inorganic ions and heavy metals is especially harmful. There is a constant need for improved drinking water, particularly for remote areas of the developing world where people live without access to safe water for drinking, cooking and bathing. Lack of clean water contributes to pediatric diarrheal diseases and associated casualties, among others.

Various types of absorbent materials or compositions are used for the treatment and purification of water contaminated with residuals, heavy metals, organics, industrial waste or by-products (industrial wastewater), urban runoff, microorganisms or other impurities. The absorbent materials or compositions can be, for example, porous, sponge-like, or fibrous. Contaminated water can be transmitted through the absorbent material or composition, and impurities can be chemically (by chemisorption) or physically (by physisorption) be bound to an interior or exterior surface of absorbent material or composition while purified water is allowed to pass therethrough.

Zeolites are microporous, aluminosilicate materials commonly used as adsorbents. Specifically, zeolites are widely used as ion-exchange beads in domestic and commercial water purification, softening, and other applications. Zeolites occur naturally but are also produced industrially on a large scale. To date, over 230 unique zeolite frameworks have been identified, at least 40 of which are naturally occurring. Despite the use of zeolites in water purification, they are not known to absorb heavy metals.

At present, the preparation of graphene from graphite by chemical methods enables scaling in production and ensures large-scale industrial exploitation. In particular, oxidation and exfoliating graphite is the most widespread method. The production of graphite oxide via oxidation of graphite with a strong oxidizing agent has been known since the nineteenth century. Specifically, the famous “Hummers method” used sodium nitrate, potassium permanganate and concentrated sulfuric acid to convert graphite to graphite oxide (Hummers W. S., Offeman R. E. Preparation of Graphitic Oxide, J. Am. Chem. Soc., 1958, 80(6), 1339-1339). Subsequent exfoliation and delamination processes, using an external force such as sonication or thermal shock with or without the assistance of ion intercalation, can be used to convert graphite oxide to graphene oxide. Graphene oxide can then be reduced to form reduced graphene oxide (rGO) or graphene. Graphene (sheet of sp² hybridized carbon and monoatomic thickness) has attracted great interest in recent years due to the unique electronic and mechanical properties presented. These make it interesting for many applications such as conversion and storage of energy (solar cells, supercapacitors), electronics (circuits based on graphene), etc. (See, for example, Camblor et al., Microwave frequency tripler based on a microstrip gap with graphene, J. Electromag. Waves Appl., 2011, 25 (14-15), 1921-1929).

At present the preparation of graphene from graphite ore by chemical methods is the one method that provides for scaling in production and is the most promising in terms of large-scale industrial exploitation. In particular, oxidation/exfoliating/reduction of naturally-occurring graphite ore is the most widespread method producing graphite oxide/graphene oxide/graphene. In this process, the oxidation of three-dimensional graphite material having a lamellar structure yields graphite sheets with oxidized basal planes and borders having an expanded three-dimensional structure. The delamination/exfoliation of graphite oxide using an external force such as sonication yields a material called graphene oxide. Finally, reducing the graphene oxide to form unilamellar (single layer) sheets, which can be produced by various methods, results in the graphene. Furthermore, in addition to the well-known benefits of graphene, the intermediate products (graphite oxide and graphene oxide) are materials which in and of themselves have much interest and commercial application. See, e.g., González Z., Botas C, Alvarez P., Roldán S., Blanco C, Santamaría R., Granda M., Menendez R., “Thermally reduced graphite oxide as positive electrode in vanadium redox flow batteries.” Carbón, 2012, 50 (3), 828-834.

Different from graphite or graphene, boron nitride is highly inert in oxidative environments. More specifically, it is stable against heating to temperatures of 800° C. or higher in oxygen-containing environments and in the presence of strong oxidizing acids. (See, for example, US 2011/0045223 A1 by Lin et al.). Boron nitride shows promise for a variety of applications due to its unique structural, electrical and chemical characteristics. Boron nitride is of interest due to its excellent mechanical properties and has found use in insulation and radiation shielding applications. With regard to radiation shielding, boron nitride materials have found utility in harsh environments such as high-altitude aerospace flights, space exploration and military applications (armor) as well as conventional radiation shielding for conventional applications (automobile, solar energy housing and buildings, cosmetics, clothing, blankets, helmets and so on. (See, for example, EP 2567385 A1 by Kang et al.).

There are numerous references on the production of boron nitride and the dispersal of commercially available boron nitride powders. There can be found numerous references to the use of graphite as a precursor in the preparation of graphene. The main feature that makes interesting material graphite in preparing graphene its polycrystalline structure is anisotropic, carbon composite sheets (sp²-bonded covalently graphene-like carbon) but stacked three-dimensionally by relatively strong Van Der Waals force. Hexagonal boron nitride (h-BN), sometimes called white graphite, is structurally analogous to graphite, with the layered sheets similarly held together by van der Waals forces. Compared to the all-carbon structure of graphene, each h-BN sheet is composed of boron and nitrogen atoms alternatively positioned in the planar hexagonal crystal structure. The interlayer structure of h-BN is such that the boron and nitrogen atoms in adjacent layers eclipse one another due to the polarity of the two atoms, forming so-called AB stacking.

### BRIEF DESCRIPTION OF THE DRAWINGS

FIG. 1 is an illustration of a system for the purification of contaminated fluid according to various aspects of the present disclosure;

FIG. 2 is a cross-sectional view of a filter assembly for the purification of contaminated fluid according to various aspects of the present disclosure; and

FIG. 3. is a cross-sectional view of another filter assembly for the purification of contaminated fluid according to various aspects of the present disclosure.

### DETAILED DESCRIPTION

The following description of the embodiments is merely exemplary in nature and is in no way intended to limit the subject matter of the present disclosure, their application, or uses.

As used throughout, ranges are used as shorthand for describing each and every value that is within the range. Any value within the range can be selected as the terminus of the range. Unless otherwise specified, all percentages and amounts expressed herein and elsewhere in the specification should be understood to refer to percentages by weight.

For the purposes of this specification and appended claims, unless otherwise indicated, all numbers expressing quantities, percentages or proportions, and other numerical values used in the specification and claims, are to be understood as being modified in all instances by the term “about.” The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent, alternatively ±5 percent, and alternatively ±1 percent of the given numeric value provided such a deviation does not alter the end function or result of the value. Accordingly, unless indicated to the contrary, the numerical parameters set forth in this specification and attached claims are approximations that can vary depending upon the desired properties sought to be obtained by the present invention.

It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. For example, as used in this specification and the following claims, the terms “comprise” (as well as forms, derivatives, or variations thereof, such as “comprising” and “comprises”), “include” (as well as forms, derivatives, or variations thereof, such as “including” and “includes”) and “has” (as well as forms, derivatives, or variations thereof, such as “having” and “have”) are inclusive (i.e., open-ended) and do not exclude additional elements or steps. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

For the purposes of this specification and appended claims, the term “coupled” refers to the linking or connection of two objects. The coupling can be permanent or reversible. The coupling can be direct or indirect. An indirect coupling includes connecting two objects through one or more intermediary objects. The term “fluidically coupled” refers to the linking or connection of two objects which allows for the flow of a fluid (that is, a liquid, solution, or gas) between the two objects. The term “fluid communication” means the flow of a fluid from one object to another object. The term “substantially” refers to an element essentially conforming to the particular dimension, shape or other word that substantially modifies, such that the component need not be exact. For example, substantially circular means that the object resembles a circle, but can have one or more deviations from a true circle.

Various aspect of the present disclosure are performed using a Pyrex® bowl or container. One of ordinary skill in the art will readily appreciate that Pyrex® is a registered trademark for low-thermal-expansion borosilicate glass or tempered soda-lime glass used for laboratory glassware. Furthermore, one of ordinary skill in the art will readily appreciate that the present disclosure is not limited to the use of Pyrex® as described. Any other suitable material can be used.

Various aspects of the present disclosure are directed toward the use of graphite and derivatives thereof. In particular, various aspects of the present disclosure are directed toward methods for preparing compositions having graphite oxide, graphene oxide and/or reduced graphene oxide and one or more of boron nitride, rare earth elements, complexes or minerals composed at least in part of rare earth elements, and ionic salts. The rare earth elements can be elemental or in the form of salts, complexes, minerals. The compositions may be made in the form of films, powders, porous bricks, porous sheets, or sponge-like materials. Zeolites can also be added to the compositions for the treatment of fluids contaminated with residuals, industrial waste or by-products (industrial wastewater), urban runoff, heavy metals, organics, or other impurities. In some instances, iron (II) or iron (III) sulfate can also be added to the compositions for purification of water by flocculation and for phosphate removal in municipal and industrial sewage treatment plants. Such compositions can be applied to various sectors such as thermal and electrical insulation, high-speed cables, super batteries, flexible touch screens, medicinal applications, textiles manufacturing, reinforced plastics, ceramics and metals, water desalination, microelectronics, solar cells, catalysis, transistors, ultrasensitive chemical detectors, air purification, water purification, and polymer additives.

While various aspects of the present disclosure are directed to the use of graphite derivatives, specifically graphite oxide, graphene oxide and/or graphene, one of ordinary skill in the art will appreciate that other carbonaceous materials, or allotropes of carbon, such as charcoal, activated charcoal, bone char, biochar, soot, coke, coal, carbon black fullerenes, single- or multiwalled carbon nanotubes, carbon nanosheets, amorphous carbon, or other carbonaceous materials can be used without imparting from the scope of the present disclosure.

As used herein, the phrase “rare earth elements” means cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb) and yttrium (Y).

As used herein, the phrase “ionic salts” means a chemical compound comprising cations and anions held together by electrostatic forces termed ionic bonding. Ionic salts used in the present disclosure can include cations such as, but not limited to, Li⁺, Na⁺, K⁺, Be²⁺, Mg²⁺, Ca²⁺, Sr²⁺, Ba²⁺, Al³⁺, Ga³⁺, In³⁺, Si⁴⁺, Ge⁴⁺, Sn⁴⁺, Sn²⁺, Zn²⁺, Zr⁴⁺, Hf⁺, Mo⁶⁺, W⁶⁺, Ag⁺, titanium ions, vanadium ions, chromium ions, manganese ions, iron ions, nickel ions, copper ions, palladium ions, platinum ions, gold ions, NH₄⁺, PH₄⁺, primary ammonium or phosphonium cations, secondary ammonium phosphonium cations, tertiary ammonium or phosphonium cations, and quaternary ammonium or phosphonium cations. Ionic salts used in the present disclosure can include anions such as, but not limited to, halides, nitrate, nitrite, sulfite, sulfate, hydrogen sulfate, hydroxide, cyanide, phosphate, hydrogen phosphate, dihydrogen phosphate, thiocyanate, carbonate, bicarbonate, hypochlorite, chlorite, chlorate, perchlorate, hypobromite, bromite, bromate, perbromate, hypoiodite, iodite, iodate, periodate, acetate, permanganate, chromate, dichromate, oxalate, thiosulfate, amide. In some instances, the ionic salts used in the present disclosure can be ionic salts of fatty acids such as, for example sodium oleate, sodium palmitate, and sodium stearate. In some instances, the ionic salts used in the present disclosure can be a surfactant having a hydrophobic tail group and either a cationic or anionic head group balanced by a counterion. Examples of anionic surfactants include, but are not limited to, lauryl sulfates, laureth sulfates, myreth sulfates, docusate, carboxylate-based fluorosurfactants, and perfluoroaylkylsulfonates. Examples of cationic surfactants include, but are not limited to, cetrimonium bromide, cetylpyridinium chloride, benzalkonium chloride dimethyldioctadecylammonium chloride, and dioctadecyldimethylammonium bromide.

In some instances, compositions according to various aspects of the present disclosure can be formed according to the following methodology. First, predetermined amounts of one or more components comprising a zeolite, boron nitride, rare earth elements, ionic salts and iron (II) or iron (III) sulfate can be subjected to ultrafine grinding. In some instances, the above components are ground such that each have particle sizes less than about 150 micrometers (μm) in diameter. In some instances, the above components are ground such that each have particle sizes ranging from about 50 to about 150 μm in diameter, alternatively from about 100 to about 150 μm in diameter. The one or more ground components are then added to a dispersion containing a solvent and one or more of graphite oxide, graphene oxide and graphene to form a composite mixture.

In some instances, the one or more ground components includes one or more of graphite oxide, graphene oxide and graphene, but do not include a zeolite. In such instances, the one or more ground components (that is, boron nitride, rare earth elements, ionic salts and iron (II) or iron (III) sulfate and graphite oxide, graphene oxide and/or graphene) are added to a dispersion containing a zeolite.

The solvent can be, for example, water. In some instances the solvent can be an alcohol, a chlorinated solvent such as chloroform of methylene chloride, an ether, an ester, a ketone, an acidic solution, a basic solution, or any other suitable solvent or solvent system known to one of ordinary skill in the art.

The composite mixture is then agitated until homogeneous or substantially homogeneous. Agitation can be performed by, for example, sonication, ultrasonication, or ultrasonic mixing in a bath or using a probe, mechanical or magnetic stirring, shaking, or any other suitable agitation method know to one of ordinary skill in the art. Agitation can be performed over a time ranging from about 30 minutes to about 2 hours, alternatively about 30 minutes to about 1.5 hours, and alternatively about 1 hour. After agitation is complete, the composite mixture is dried to form the final product. In some instances, drying can be accomplished under ambient conditions or under vacuum using an oven. In other instances, drying can be accomplished using an infrared light source under ambient conditions or under vacuum. In other instances the composite mixture can be dried via lyophilization to form the final product. In some instances, the composite mixture can be dried to form a powder. In other instances, the composite mixture can be dried applied as a thin layer, or series of thin layers, on a substrate to form a film. In yet other instances, the composite mixture can be dried in a three-dimensional container such that upon drying, the final product is a solid brick or sponge-like material in the form of the internal dimensions of said three-dimensional container.

Preferably, all of the above stages are performed at temperatures of less than about 200° C., and more preferably less than about 100° C. The above stages, however, are not strictly limited to such temperature requirements.

In some instances, a portion solvent can be removed from the mixture prior to drying. For example, in some instances, the mixture can be subjected to centrifugation at a rate ranging from about 2000 to about 6000 rpm, alternatively about 3000 to about 5000 rpm, and alternatively about 4000 rpm for a period of time ranging from about 5 to about 30 minutes, alternatively about 5 to about 15 minutes, and alternatively about 10 minutes. After centrifugation is complete, a portion of the solvent can be removed by, for example, decanting. In other instances, a portion of the solvent can be removed by gravity or vacuum filtration.

In some instances, prior to drying, prior to centrifugation or filtration, or during the centrifugation or filtration procedure the composite mixture can be subjected to one or more washing steps until the mixture, more specifically the solvent, has a desirable pH. In some instances, prior to drying, the composite mixture can be subjected to dialysis to remove unwanted ions or other impurities from the composite mixture.

In some instances, the predetermined amounts of one or more components comprising a zeolite, boron nitride, rare earth elements, ionic salts and iron (II) or iron (III) sulfate are not subjected to ultrafine grinding. Instead, the predetermined amounts of the components are used as received and directly added to the dispersion containing one or more of graphite oxide, graphene oxide and graphene and the solvent to form the composite mixture.

In some instances, the addition of one or more of boron nitride, rare earth elements, ionic salts, a zeolite, iron (II) or iron (III) sulfate to the one or more of graphite oxide, graphene oxide and graphene-containing dispersion is conducted by a chemical treatment using weight ratios of graphite oxide, graphene oxide, and/or graphene to boron nitride from about 1:0.01 to about 1:2 depending on the final product desired, weight ratios of graphite oxide, graphene oxide, and/or graphene to rare earth elements from about 1:0.01 to about 1:2 depending on the final product desired, weight ratios of graphite oxide, graphene oxide, and/or graphene to ionic salts from about 1:0.01 to about 1:2 depending on final product desired, weight ratios of graphite oxide, graphene oxide, and/or graphene to zeolite from about 1:0.01 to about 1:2 depending on the final product desired, and weight ratios of graphene oxide and/or graphene to iron(II) or iron (III) sulfate from about 1:0.01 to about 1:2, or any combination thereof, depending on the final product desired. The combined amount of solids (i.e. graphite oxide, graphene oxide and/or graphene and above components) should be dispersed in a solvent, such as water (distilled, bi-distilled, deionized, Millipore, etc.), in a ratio ranging from about 1 mg (solids)/ml (solvent) to about 10 mg/ml, alternatively from about 2 mg/ml to about 8 mg/ml, alternatively from about 3 mg/ml to about 6 mg/ml, alternatively from about 4 mg/ml to about 5 mg/ml, and alternatively about 4 mg/ml.

In some instances, compositions according to various aspects of the present disclosure can be formed according to the following methodology. First, predetermined amounts of a zeolite and boron nitride can subjected to ultrafine grinding. In some instance, the zeolite and boron nitride are ground such that each have particle sizes less than about 150 micrometers (μm) in diameter. In some instances, the above components are ground such that each have particle sizes ranging from about 50 to about 150 μm in diameter, alternatively from about 100 to about 150 μm in diameter. The ground zeolite and boron nitride are then added to a dispersion containing a solvent and one or more of graphite oxide, graphene oxide and graphene to form a composite mixture. The solvent can be, for example, water. In some instances the solvent can be an alcohol, a chlorinated solvent such as chloroform of methylene chloride, an ether, an ester, a ketone, an acidic solution, a basic solution, or any other suitable solvent or solvent system known to one of ordinary skill in the art.

The composite mixture is then agitated to ensure homogeneity of the mixture. The composite mixture is then agitated until homogeneous or substantially homogeneous. Agitation can be performed by, for example, sonication, ultrasonication, or ultrasonic mixing in a bath or using a probe, mechanical or magnetic stirring, shaking, or any other suitable agitation method know to one of ordinary skill in the art. Agitation can be performed over a time ranging from about 30 minutes to about 2 hours, alternatively about 30 minutes to about 1.5 hours, and alternatively about 1 hour. After agitation is complete, the mixture is dried to form the final product. In some instances, drying can be accomplished under ambient conditions or under vacuum using an oven. In other instances, drying can be accomplished using an infrared light source under ambient conditions or under vacuum. In other instances the composite mixture can be dried via lyophilization to form the final product. In some instances, the composite mixture can be dried to form a powder. In other instances, the composite mixture can be dried applied as a thin layer, or series of thin layers, on a substrate to form a film. In yet other instances, the composite mixture can be dried in a three-dimensional container such that upon drying, the final product is a solid brick or sponge-like material in the form of the internal dimensions of said three-dimensional container.

In some instances, the predetermined amounts of the zeolite and the boron nitride are not subjected to ultrafine grinding. Instead, the predetermined amounts of the of the zeolite and the boron nitride are used as received and directly added to the dispersion containing one or more of graphite oxide, graphene oxide and graphene and the solvent to form the mixture.

In some instances, a portion solvent can be removed from the mixture prior to drying. For example, in some instances, the mixture can be subjected to centrifugation at a rate ranging from about 2000 to about 6000 rpm, alternatively about 3000 to about 5000 rpm, and alternatively about 4000 rpm for a period of time ranging from about 5 to about 30 minutes, alternatively about 5 to about 15 minutes, and alternatively about 10 minutes. After centrifugation is complete, a portion of the solvent can be removed by, for example, decanting. In other instances, a portion of the solvent can be removed by gravity or vacuum filtration.

In some instances, prior to drying, prior to centrifugation or filtration, or during the centrifugation or filtration procedure the mixture can be subjected to one or more washing steps until the mixture, more specifically the solvent, has a desirable pH. In some instances, prior to drying, the composite mixture can be subjected to dialysis to remove unwanted ions or other impurities from the composite mixture.

Preferably, all of the above stages are performed at temperatures of less than about 200° C., and more preferably less than about 100° C. The above stages, however, are not strictly limited to such temperature requirements.

In some instances, the addition of one or more of boron nitride and a zeolite to the one or more of graphite oxide, graphene oxide and graphene-containing dispersion is conducted by a chemical treatment using weight ratios of zeolite to graphite oxide, graphene oxide, and/or graphene ranging from about 100:0.001 to about 100:0.01 depending on the final product desired, and weight ratios of zeolite to boron nitride ranging from about 100:0.005 to about 100:0.05. The combined amount of solids (i.e. graphite oxide, graphene oxide and/or graphene and zeolite and boron nitride) should be dispersed in a solvent, such as water (distilled, bi-distilled, deionized, Millipore, etc.), in a ratio ranging from about 1 mg (solids)/ml (solvent) to about 10 mg/ml, alternatively from about 2 mg/ml to about 8 mg/ml, alternatively from about 3 mg/ml to about 6 mg/ml, alternatively from about 4 mg/ml to about 5 mg/ml, and alternatively about 4 mg/ml.

When boron nitride is used, the boron nitride can be boron nitride powder, hexagonal boron nitride (h-BN), boron nitride nanofibers, nanosheets, or nanotubes. The rare earth elements and ionic salts can also be in the form of powders.

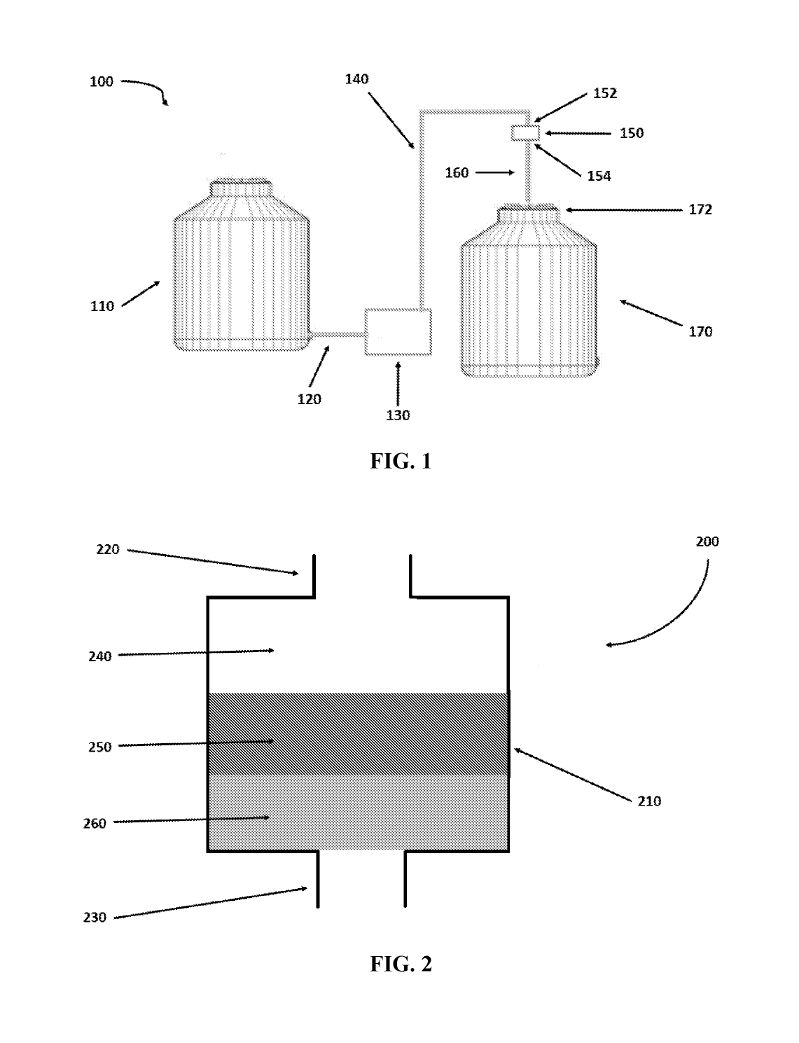

FIG. 1 is an illustration of a system for the purification of contaminated water according to various aspects of the present disclosure. The system 100 includes a contaminated fluid source 110, a filter assembly 150, and a purified water container 170. Contaminated fluid exits the contaminated fluid source 110 via an outlet pipe 120 and is transmitted to a pump 130. The pump 130 then transmits the contaminated fluid to a filter inlet 152 of the filter assembly 150 via a pipe 140. The contaminated fluid is passed through one or more absorbent media (not shown) contained within the filter assembly 150. Purified fluid then exits the filter assembly 150 through a filter outlet 154 and is transmitted to an inlet 172 of the purified fluid container 170 via a pipe 160. The contaminated fluid can be any one of contaminated water, an aqueous solution, a contaminated gas, a mixture of gases, or any combination thereof.

The shape of the filter assembly 150 is not particularly limiting. In some instances, the filter assembly 150 can be cylindrical. In other instances, the filter assembly 150 can be spherical or ovoid. In other instances, the filter assembly 150 can be cubic. In yet other instances, the filter assembly 150 can be any one of rectangular prismatic, square prismatic, triangular prismatic, hexagonal prismatic, or any other suitable prismatic shape. In yet other instances, the filter assembly 150 can be conical, frustoconical, triangular pyramidal or square pyramidal, and taper inward or outward from the filter inlet 152 to the filter outlet 154.

FIG. 2 is a cross-sectional view of a filter assembly for the purification of contaminated water according to various aspects of the present disclosure. The filter assembly 200 includes a housing 210, a contaminated fluid inlet 220, and a purified fluid outlet 230. Absorbent media 240, 250, 260 are contained within the housing 210. Each of the absorbent media 240, 250, 260 are in the form of a powder, porous brick, sponge-like material, fibrous material, or any combination thereof. Each absorbent media 240, 250, 260 can be made of a different material. In some instances, the absorbent media 240 can be made of one or more zeolites. In some instances, the absorbent media 250 can be made of a mixture of one or more zeolites and graphene oxide. In some instances, the absorbent media 260 can be made of a mixture of one or more zeolites and a boron nitride. The boron nitride can be hexagonal boron nitride (h-BN).

In FIG. 2, the absorbent media 240 and the absorbent media 250 are in direct contact and the absorbent media 250 and the absorbent media 260 are in direct contact. In some instances, each of the absorbent media 240, 250, 260 can be separated by a porous material. The porous material can be, for example, a disk having a plurality of passageways extending longitudinally therethrough for fluid communication between adjacent absorbent media. The disk can be made of an inert material such as, for example, polytetrafluoroethylene (PTFE) or can be a glass filter frit. The material of which the disk is composed can be chemically inert or can also serve as an additional means of treating or purifying the contaminated fluid. In other instances each of the absorbent media 240, 250, 260 can be separated by a woven or mesh material. The woven or mesh material can be, for example, a metal or alloy wire mesh, a woven polymer, a woven fabric or textile, or any other suitable woven or mesh material. The woven or mesh material can be chemically inert or can also serve as an additional means of treating or purifying the contaminated fluid.

In FIG. 2, the absorbent media 260 are in direct contact with a bottom surface of the housing 210 and the purified fluid outlet 230. In some instances, the absorbent media 260 can be separated from the bottom surface of the housing 210 and the purified fluid outlet 230 by a porous material. The porous material can be, for example, a disk having a plurality of the passageways therethrough for fluid communication between adjacent absorbent media. The disk can be made of an inert material such as, for example, polytetrafluoroethylene (PTFE) or can be a glass filter frit. The material from which the disk is made disk can be chemically inert or can also serve as an additional means of treating or purifying the contaminated fluid. In other instances, the absorbent media 260 can be separated from the bottom surface of the housing 210 and the purified fluid outlet 230 by a woven or mesh material. The woven or mesh material can be, for example, a metal or alloy wire mesh, a woven organic polymer, a woven fabric or textile, or any other suitable woven or mesh material. The woven or mesh material can be chemically inert or can also serve as an additional means of treating or purifying the contaminated fluid.

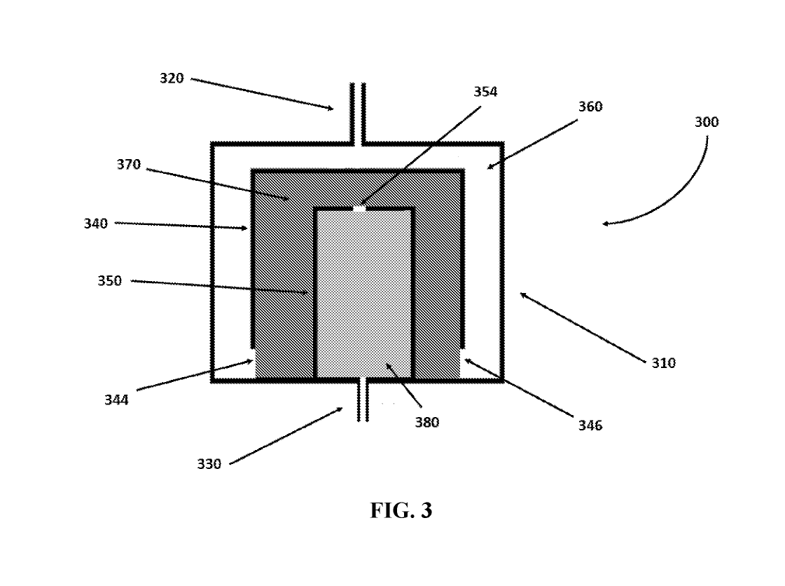

FIG. 3. is a cross-sectional view of another filter assembly for the purification of contaminated fluid according to various aspects of the present disclosure. The filter assembly 300 includes a main housing 310, a contaminated fluid inlet 320, and a purified fluid inlet 320. The filter assembly further includes a first absorbent media 360, a second absorbent media 370 and a third absorbent media 380. The first absorbent media 360 and the second absorbent media 370 are partially separated from each other via a first sub-housing 340. The second absorbent media 370 and the third absorbent media 380 are partially separated from each other by a second sub-housing 350. In use, a contaminated fluid enters the housing 310 via the inlet 320 and is made to pass through the first absorbent media 360. Upon passing through, and being at least partially purified by, the first absorbent media 360, the fluid then enters the first sub-housing 340 via passageways 344, 346 to be further purified by the second absorbent media 370. Upon passing through, and being at least partially purified by, the second absorbent media 370, the fluid then enters the second sub-housing 350 via passageway 354 to be further purified by the third absorbent media 380. Upon passing through, and being purified by, the third absorbent media. 380, the purified fluid then exits the filter assembly 300 via the outlet 330.

Each of the absorbent media 360, 370, 380 are in the form of a porous brick, sponge-like material, fibrous material, or any combination thereof. Each absorbent media 360, 370, 380 can be made of a different material. In some instances, the first absorbent media 360 can be made of one or more zeolites. In some instances, the second absorbent media 370 can be made of a mixture of one or more zeolites and graphite oxide, graphene oxide and/or graphene. In some instances, the third absorbent media. 380 can be made of a mixture of one or more zeolites and a boron nitride. The boron nitride can be hexagonal boron nitride (h-BN).

In FIG. 3, the first sub-housing 340 is illustrated as having two passageways 344, 346. In some instances, the first sub-housing 340 can have only a single passageway. In other instances, the sub-housing 340 can have more than two passageways such as, for example, from about 3 to about 20 passageways, alternatively from about 4 to about 16 passageways, and alternatively about 6 to about 12 passageways. The passageways can be any diameter suitable for efficient passage of fluid therethrough, allowing for fluid communication between the first absorbent media 360 and the second absorbent media 370. In any event, the passageways should positioned as far from the inlet as possible such that the contaminated fluid traverses a maximized amount of the first absorbent media 360.

In FIG. 3, the second sub-housing 350 is illustrated as having one passageway 354. In some instances, the sub-housing 340 can have more than one passageway such as, for example, from about 2 to about 20 passageways, alternatively from about 4 to about 16 passageways, and alternatively from about 6 to about 12 passageways. The passageways can be any diameter suitable for efficient passage of fluid therethrough, allowing for fluid communication between the second absorbent media 370 and the third absorbent media 380. In any event, the passageways should positioned as far as possible from the passageways 344, 346 of the first sub-housing 340 such that the contaminated fluid traverses a maximized amount of the second absorbent media 370. Additionally, the passageway 354 should be positioned as far as possible from the purified fluid outlet 330 such that the contaminated fluid traverses a maximized amount of the third absorbent media 380.

In some instances, absorbent media, made according to various aspects of the present disclosure, comprising graphite oxide, graphene oxide and/or graphene and one or more of the above identified components can be used with a physical external energy source for use as a heat transfer medium or catalyst. In other instances, absorbent media, made according to various aspects of the present disclosure, comprising graphite oxide, graphene oxide and/or graphene and one or more of the above identified components can be used with a chemical external energy source for use as a heat transfer medium or catalyst.

In some instances, absorbent media comprising graphite oxide, graphene oxide and or graphene and one or more boron nitride, made according to various aspects of the present disclosure, can be used for chemical detection, via the trapping of molecules or analytes of interest, or related applications.

In some instances, absorbent media comprising graphite oxide, graphene oxide and or graphene and one or more rare earth elements, made according to various aspects of the present disclosure, can be used for chemical detection, via the trapping of molecules or analytes of interest, or related applications.

In some instances, absorbent media comprising graphite oxide, graphene oxide and or graphene and one or more ionic salts, made according to various aspects of the present disclosure, can be used for chemical detection, via the trapping of molecules or analytes of interest, ion-exchange, or related applications.

In some instances, absorbent media comprising graphite oxide, graphene oxide and or graphene and one or more zeolites, made according to various aspects of the present disclosure, can be used for chemical detection, via the trapping of molecules or analytes of interest, ion-exchange, or related applications.

In some instances, absorbent media comprising graphite oxide, graphene oxide and or graphene and iron (II) and/or iron (III) sulfate, made according to various aspects of the present disclosure, can be used for chemical detection, via the trapping of molecules or analytes of interest, or related applications.

In some instances, absorbent media comprising graphite oxide, graphene oxide and or graphene, boron nitride and one or more zeolites, made according to various aspects of the present disclosure, can be used for chemical detection, via the trapping of molecules or analytes of interest, ion-exchange, or related applications.

Statements of the Disclosure include:

Statement 1: A filter assembly, the assembly comprising a main housing defining an first internal fluid passageway; a first sub-housing within the main housing and defining a second internal fluid passageway, the second internal fluid passageway in fluid communication with the first internal fluid passageway; a second sub-housing within the first sub-housing, and defining a third internal fluid passageway, the third internal fluid passageway in fluid communication with the second internal fluid passageway; a fluid inlet in fluid communication with the main housing; a fluid outlet in fluid communication with the second sub-housing; a first absorbent media inside the main housing and surrounding the first sub-housing; a second absorbent media inside the first sub-housing and surrounding the second sub-housing; and a third absorbent media inside the second sub-housing.

Statement 2: A filter assembly according to Statement 1, wherein the first absorbent media comprises a zeolite.

Statement 3: A filter assembly according to Statement 1 or Statement 2, wherein the second absorbent media comprises a zeolite and a boron nitride.

Statement 4: A filter assembly according to Statement 3, wherein the boron nitride is in the form of hexagonal boron nitride (h-BN), a powder, a nanofiber, a nanosheet, a nanotube, or any combination thereof.

Statement 5: A filter assembly according to any one of Statements 1-4, wherein the third absorbent media comprises a zeolite and one or more of graphite oxide, graphene oxide and graphene.

Statement 6: A filter assembly according to any one of Statements 1-5, wherein one or more of the first absorbent media, the second absorbent media, and the third absorbent media further comprises a rare earth element.

Statement 7: A filter assembly according to any one of Statements 1-6, wherein one or more of the first absorbent media, the second absorbent media, and the third absorbent media further comprises an ionic salt.

Statement 8: A filter assembly according to any one of Statements 1-7, wherein one or more of the first absorbent media, the second absorbent media, and the third absorbent media further comprises an iron sulfate.

Statement 9: A filter assembly according to Statement 1, wherein one or more of the first absorbent media, the second absorbent media, and the third absorbent media comprise a zeolite; a boron nitride; and one or more of graphite oxide, graphene oxide and graphene.

Statement 10: A filter assembly according to Statement 9, wherein the boron nitride is in the form of hexagonal boron nitride (h-BN), a powder, a nanofiber, a nanosheet, a nanotube, or any combination thereof.

Statement 11: A filter assembly according to Statement 9 or Statement 10, wherein the zeolite and the one or more of graphite oxide, graphene oxide and graphene are present in a weight ratio ranging from about 100:0.001 to about 100:0.01.

Statement 12: A filter assembly according to any one of Statements 9-11, wherein the zeolite and the boron nitride are present in a weight ratio ranging from about 100:0.005 to about 100:0.05.

Statement 13: A filter assembly according to Statement 1, wherein one or more of the first absorbent media, the second absorbent media, and the third absorbent media comprise one or more of graphite oxide, graphene oxide and graphene; and one or more of a zeolite, a boron nitride, a rare earth element, an ionic salt, and an iron sulfate.

Statement 14: A filter assembly according to Statement 13, wherein the one or more of graphite oxide, graphene oxide and graphene and the boron nitride are present in a weight ratio ranging from about 1:0.01 to about 1:2.

Statement 15: A filter assembly according to Statement 13 or Statement 14, wherein the one or more of graphite oxide, graphene oxide and graphene and the zeolite are present in a weight ratio ranging from about 1:0.01 to about 1:2.

Statement 16: A filter assembly according to any one of Statements 13-15, wherein the one or more of graphite oxide, graphene oxide and graphene and the rare earth element are present in a weight ratio ranging from about 1:0.01 to about 1:2.

Statement 17: A filter assembly according to any one of Statements 13-16, wherein the one or more of graphite oxide, graphene oxide and graphene and the ionic salt are present in a weight ratio ranging from about 1:0.01 to about 1:2.

Statement 18: A filter assembly according to any one of Statements 13-17, wherein the one or more of graphite oxide, graphene oxide and graphene and the iron sulfate are present in a weight ratio ranging from about 1:0.01 to about 1:2.

Statement 19: A filter assembly, the assembly comprising a housing defining an internal fluid passageway having a distal end and a proximal end; a fluid inlet fluidically coupled with the proximal end; a fluid outlet fluidically coupled with the distal end; a first absorbent media adjacent to the proximal end; a second absorbent media adjacent to the distal end; and a third absorbent media between the first absorbent media and the second absorbent media.

Statement 20: A filter assembly according to Statement 19, wherein the first absorbent media comprises a zeolite.

Statement 21: A filter assembly according to Statement 19 or Statement 20, wherein the second absorbent media comprises a zeolite and a boron nitride.

Statement 22: A filter assembly according to Statement 21, wherein the boron nitride is in the form of hexagonal boron nitride (h-BN), a powder, a nanofiber, a nanosheet, a nanotube, or any combination thereof.

Statement 23: A filter assembly according to any one of Statements 19-22, wherein the third absorbent media comprises a zeolite; and one or more of graphite oxide, graphene oxide and graphene.

Statement 24: A filter assembly according to any one of Statements 19-23, wherein one or more of the first absorbent media, the second absorbent media, and the third absorbent media further comprises a rare earth element.

Statement 25: A filter assembly according to any one of Statements 19-24, wherein one or more of the first absorbent media, the second absorbent media, and the third absorbent media further comprises an ionic salt.

Statement 26: A filter assembly according to any one of Statements 19-25, wherein one or more of the first absorbent media, the second absorbent media, and the third absorbent media further comprises an iron sulfate.

Statement 27: A filter assembly according to Statement 19, wherein one or more of the first absorbent media, the second absorbent media, and the third absorbent media comprise a zeolite; a boron nitride; and one or more of graphite oxide, graphene oxide and graphene.

Statement 28: A filter assembly according to Statement 27, wherein the boron nitride is in the form of hexagonal boron nitride (h-BN), a powder, a nanofiber, a nanosheet, a nanotube, or any combination thereof.

Statement 29: A filter assembly according to Statement 27 or Statement 28, wherein the zeolite and the one or more of graphite oxide, graphene oxide and graphene are present in a weight ratio ranging from about 100:0.001 to about 100:0.01.

Statement 30: A filter assembly according to any one of Statements 27-29, wherein the zeolite and the boron nitride are present in a weight ratio ranging from about 100:0.005 to about 100:0.05.

Statement 31: A filter assembly according to Statement 19, wherein one or more of the first absorbent media, the second absorbent media, and the third absorbent media comprise one or more of graphite oxide, graphene oxide and graphene; and one or more of a zeolite, a boron nitride, a rare earth element, an ionic salt, and an iron sulfate.

Statement 32: A filter assembly according to Statement 31, wherein the one or more of graphite oxide, graphene oxide and graphene and the boron nitride are present in a weight ratio ranging from about 1:0.01 to about 1:2.

Statement 33: A filter assembly according to Statement 31 or Statement 32, wherein the one or more of graphite oxide, graphene oxide and graphene and the zeolite are present in a weight ratio ranging from about 1:0.01 to about 1:2.

Statement 34: A filter assembly according to any one of Statements 31-33, wherein the one or more of graphite oxide, graphene oxide and graphene and the rare earth element are present in a weight ratio ranging from about 1:0.01 to about 1:2.

Statement 35: A filter assembly according to any one of Statements 31-34, wherein the one or more of graphite oxide, graphene oxide and graphene and the ionic salt are present in a weight ratio ranging from about 1:0.01 to about 1:2.

Statement 36: A filter assembly according to any one of Statements 31-35, wherein the one or more of graphite oxide, graphene oxide and graphene and the iron sulfate are present in a weight ratio ranging from about 1:0.01 to about 1:2.

Statement 37: A method for making an absorbent media, the method comprising grinding a predetermined amount of a first material comprising one or more of a zeolite, a boron nitride, a rare earth element, an ionic salt, and an iron sulfate to provide particles of the first material having diameters of 150 μm or less; adding the ground first material particles into a dispersion to form a composite mixture, the dispersion comprising a solvent and one or more of graphite oxide, graphene oxide and graphene; homogenizing the composite mixture; and drying the homogenized composite mixture.

Statement 38: A method according to Statement 37, wherein the solvent comprises one or more of water, a chlorinated solvent, an ether, an ester, a ketone, an acidic solution, and a basic solution.

Statement 39: A method according to Statement 37 or Statement 38, wherein the homogenizing the composite mixture is performed by any one of sonication, ultrasonication, or ultrasonic mixing, mechanical stirring, magnetic stirring, and shaking.

Statement 40: A method according to any one of Statements 37-39, wherein the homogenizing the composite mixture is performed over a period of time ranging from 30 minutes to 2 hours.

Statement 41: A method according to any one of Statements 37-40, wherein drying the homogenized composite mixture is performed in an oven.

Statement 42: A method according to any one of Statements 37-40, wherein drying the homogenized composite mixture is performed in a lyophilizer.

Statement 43: A method according to any one of Statements 37-42, wherein, during drying, the homogenized composite mixture is formed into any one of a film, a powder, a porous brick, or a porous sponge-like material.

Statement 44: A method according to any one of Statements 37-43, wherein the combined amount of the first material and the one or more of graphite oxide, graphene oxide and graphene and the solvent yield a composite mixture having a solid to solvent ratio ranging from about 1 mg/ml to 10 mg/ml.

Statement 45: A method according to any one of Statements 37-44, wherein the combined amount of the first material and the one or more of graphite oxide, graphene oxide and graphene and the solvent yield a composite mixture having a solid to solvent ratio ranging of about 4 mg/ml.

Statement 46: A method according to any one of Statements 37-45, wherein the zeolite and the one or more of graphite oxide, graphene oxide and graphene are present in a weight ratio ranging from about 100:0.001 to about 100:0.01.

Statement 47: A method according to any one of Statements 37-46, wherein the zeolite and the boron nitride are present in a weight ratio ranging from about 100:0.005 to about 100:0.05.

Statement 48: A method according to any one of Statements 37-47, wherein the one or more of graphite oxide, graphene oxide and graphene and the boron nitride are present in a weight ratio ranging from about 1:0.01 to about 1:2.

Statement 49: A method according to any one of Statements 37-45 and 48, wherein the one or more of graphite oxide, graphene oxide and graphene and the zeolite are present in a weight ratio ranging from about 1:0.01 to about 1:2.

Statement 50: A method according to any one of Statements 37-49, wherein the one or more of graphite oxide, graphene oxide and graphene and the rare earth element are present in a weight ratio ranging from about 1:0.01 to about 1:2.

Statement 51: A method according to any one of Statements 37-50, wherein the one or more of graphite oxide, graphene oxide and graphene and the ionic salt are present in a weight ratio ranging from about 1:0.01 to about 1:2.

Statement 52: A method according to any one of Statements 37-51, wherein the one or more of graphite oxide, graphene oxide and graphene and the iron sulfate are present in a weight ratio ranging from about 1:0.01 to about 1:2.

Statement 53: A filter assembly according to any one of statements 1-36, the filter assembly comprising an absorbent media made by a method according to any one of Statements 37-52.

Statement 54: A system for the purification of a contaminated fluid, the system comprising a contaminated fluid source comprising a contaminated fluid outlet; a purified fluid storage container comprising a purified fluid inlet; and a filter assembly according any one of Statements 1-36 coupled with the contaminated fluid outlet and the purified fluid inlet.

Statement 55: A system according to Statement 54, wherein the contaminated fluid is contaminated water, a contaminated aqueous solution, a contaminated gas, a mixture of gases, or any combination thereof.

Statement 56: A system according to Statement 54 or Statement 55, wherein contaminated fluid comprises is any one of heavy metal, a residual, industrial wastewater, urban runoff, an organic compound, a microorganism.

Statement 57: A system according to any one of Statements 54-56, further comprising a water pump coupled with the contaminated fluid outlet and the filter assembly.

### EXAMPLES

### Preparation of Graphite Oxide and Graphene Oxide

Obtaining graphite oxide from graphite ore was performed as follows. In a 4-liter beaker, 250 ml of phosphoric acid to 85% and 1750 ml of sulfuric acid at 98% were added at room temperature and stirred for 10 minutes. Subsequently, 20 g of graphite ore, having been ground to a fineness of less than about 150 microns, was added to the beaker and stirred for 10 minutes. Then, 120 grams of potassium permanganate was added slowly and the temperature was raised to 65° C. and left stirring for 8 hours. The reaction mixture was then transferred to a new 4-liter containing 2 liters of frozen bi-distilled water. 15 ml of hydrogen peroxide (30%) was added and the mixture allowed to stir at room temperature for 30 minutes. After allowing the mixture to stand for 20 hours, the supernatant was decanted. The remainder of the mixture containing the solid product was transferred to centrifuge tubes and centrifuged at 4500 rpm for 15 minutes. After centrifugation, additional supernatant was removed. The solid was subjected to successive rounds of washing and centrifugation until the remaining phosphoric acid and sulfuric acid had been removed to yield graphite oxide. The graphite oxide was then dried.

### Prophetic Example 1

Formation of a film composed of a mixture of graphene oxide and boron nitride. In a beaker, 2 grams of graphite oxide is dispersed in 500 ml of an HCl solution (pH 2.4) to form a 4 mg/ml graphite oxide dispersion. The dispersion can then be agitated in an ultrasonic bath for 60 minutes to 6 hours to form graphene oxide (GO). Next, 20 mg to 4 grams of boron nitride (BN) powder can be added to the dispersion and stirred for about 1 hour. After stirring, the HCl can be removed by successive rounds of centrifugation, decanting the supernatant and solvent washing the supernatant was decanted. The remainder of the mixture containing the solid product was transferred to centrifuge tubes and centrifuged at 4500 rpm for 15 minutes. Alternatively, after stirring, the HCl can be removed by gravity or vacuum filtration and solvent washing. The GO/BN-containing dispersion can then be placed in a Pyrex® bowl dried under ambient conditions, or under vacuum, in an oven at 40° C. to 60° C.

### Prophetic Example 2

Formation of a shaped composition composed of a mixture of graphene oxide and boron nitride. In a beaker, 2 grams of graphite oxide is dispersed in 500 ml of an HCl solution (pH 4.0) to form a 4 mg/ml graphite oxide dispersion. The dispersion can then be agitated in an ultrasonic bath for 60 minutes to 6 hours to form graphene oxide (GO). Next, 20 mg to 4 grams of boron nitride (BN) powder can be added to the dispersion and stirred for about 1 hour. After stirring, the HCl can be removed by successive rounds of centrifugation, decanting the supernatant and solvent washing the supernatant was decanted. The remainder of the mixture containing the solid product was transferred to centrifuge tubes and centrifuged at 4500 rpm for 15 minutes. Alternatively, after stirring, the HCl can be removed by gravity or vacuum filtration and solvent washing. The GO/BN-containing dispersion can then be placed in a Pyrex® bowl dried in a lyophilizer. The Pyrex® bowl can be in the shape of, for example, a cylinder, such that the GO/BN composition is formed into a brick or sponge-like consistency having a solid cylindrical shape upon completion of lyophilization.

### Example 3

In Example 3, a filter assembly 200 in accordance with FIG. 2 was prepared. First, three separate sponge-like absorbent media were prepared as outlined in prophetic examples 1 and 2. The first absorbent media was prepared using 560 g of a zeolite. The second absorbent media was prepared using 560 g of a zeolite and 20 mg of graphene oxide. The third absorbent media was prepared using 560 g of a zeolite and 100 mg of boron nitride. These blocks were arranged with the first absorbent media at the top of the filter assembly, the third absorbent media at the bottom of the filter assembly, and the second absorbent media therebetween as illustrated in FIG. 1. Each of the absorbent media can be formed into the sponge-like block via lyophilization in a Pyrex® container having a diameter approximately the same as the filter assembly housing 210 and a height approximately one-third of the height of the filter assembly housing 210. With this filter assembly up to 204 liters of contaminated water can be treated.

The three above absorbent media can also be prepared and placed in the filter assembly 300 of FIG. 3 in a similar fashion, as would be understood by one or ordinary skill in the art. For example, molds or each of the housing 310, the first sub-housing 340, and the second sub-housing 350 can be used with Pyrex® bowls having the same dimensions as the housing 310, the first sub-housing 340, and the second sub-housing 350. The molds and Pyrex® bowls can be used to make sponge-like bricks of each absorbent media and then the filter assembly of FIG. 2 can be assembled as shown.

Although the present invention and its objects, features and advantages have been described in detail, other embodiments are encompassed by the invention. Finally, those skilled in the art should appreciate that they can readily use the disclosed conception and specific embodiments as a basis for designing or modifying other structures for carrying out the same purposes of the present invention without departing from the scope of the invention as defined by the appended claims.

1. A filter assembly, the assembly comprising:
a main housing defining an first internal fluid passageway;
a first sub-housing within the main housing and defining a second internal fluid passageway, the second internal fluid passageway in fluid communication with the first internal fluid passageway;
a second sub-housing within the first sub-housing, and defining a third internal fluid passageway, the third internal fluid passageway in fluid communication with the second internal fluid passageway;
a fluid inlet in fluid communication with the main housing;
a fluid outlet in fluid communication with the second sub-housing;
a first absorbent media inside the main housing and surrounding the first sub-housing;
a second absorbent media inside the first sub-housing and surrounding the second sub-housing; and
a third absorbent media inside the second sub-housing.

2. The filter assembly of claim 1, wherein the first absorbent media comprises a zeolite.

3. The filter assembly of claim 1, wherein the second absorbent media comprises a zeolite and a boron nitride.

4. (canceled)

5. The filter assembly of claim 1, wherein the third absorbent media comprises:
a zeolite; and
one or more of graphite oxide, graphene oxide and graphene.

6. The filter assembly of claim 1, wherein one or more of the first absorbent media, the second absorbent media, and the third absorbent media comprises any one of a rare earth element, an ionic salt and an iron sulfate.

7-8. (canceled)

9. The filter assembly of claim 1, wherein one or more of the first absorbent media, the second absorbent media, and the third absorbent media comprise:
a zeolite;
a boron nitride; and
one or more of graphite oxide, graphene oxide and graphene.

10. (canceled)

11. The filter assembly of claim 9, wherein the zeolite and the one or more of graphite oxide, graphene oxide and graphene are present in a weight ratio ranging from about 100:0.001 to about 100:0.01.

12. The filter assembly of claim 9, wherein the zeolite and the boron nitride are present in a weight ratio ranging from about 100:0.005 to about 100:0.05.

13. The filter assembly of claim 1, wherein one or more of the first absorbent media, the second absorbent media, and the third absorbent media comprise:
one or more of graphite oxide, graphene oxide and graphene; and
one or more of a zeolite, a boron nitride, a rare earth element, an ionic salt, and an iron sulfate.

14. The filter assembly of claim 13, wherein the one or more of graphite oxide, graphene oxide and graphene and the one or more of the zeolite, the boron nitride, the rare earth element, the ionic salt, and the iron sulfate are present in a weight ratio ranging from about 1:0.01 to about 1:2.

15-18. (canceled)

19. A filter assembly, the assembly comprising:
a housing defining an internal fluid passageway having a distal end and a proximal end;
a fluid inlet fluidically coupled with the proximal end;
a fluid outlet fluidically coupled with the distal end;
a first absorbent media adjacent to the proximal end;
a second absorbent media adjacent to the distal end; and
a third absorbent media between the first absorbent media and the second absorbent media.

20. The filter assembly of claim 19, wherein the first absorbent media comprises a zeolite.

21. The filter assembly of claim 19, wherein the second absorbent media comprises a zeolite and a boron nitride.

22. (canceled)

23. The filter assembly of claim 19, wherein the third absorbent media comprises:
a zeolite; and
one or more of graphite oxide, graphene oxide and graphene.

24. The filter assembly of claim 19, wherein one or more of the first absorbent media, the second absorbent media, and the third absorbent media comprises any one of a rare earth element, an ionic salt and an iron sulfate.

25-26. (canceled)

27. The filter assembly of claim 19, wherein one or more of the first absorbent media, the second absorbent media, and the third absorbent media comprise:
a zeolite;
a boron nitride; and
one or more of graphite oxide, graphene oxide and graphene.

28. (canceled)

29. The filter assembly of claim 27, wherein the zeolite and the one or more of graphite oxide, graphene oxide and graphene are present in a weight ratio ranging from about 100:0.001 to about 100:0.01.

30. The filter assembly of claim 27, wherein the zeolite and the boron nitride are present in a weight ratio ranging from about 100:0.005 to about 100:0.05.

31. The filter assembly of claim 19, wherein one or more of the first absorbent media, the second absorbent media, and the third absorbent media comprise:
one or more of graphite oxide, graphene oxide and graphene; and
one or more of a zeolite, a boron nitride, a rare earth element, an ionic salt, and an iron sulfate.

32. The filter assembly of claim 31, wherein the one or more of graphite oxide, graphene oxide and graphene and the one or more of the zeolite, the boron nitride, the rare earth element, the ionic salt, and the iron sulfate are present in a weight ratio ranging from about 1:0.01 to about 1:2.

33-52. (canceled)

53. A system for the purification of a contaminated fluid, the system comprising:
a contaminated fluid source comprising a contaminated fluid outlet;
a purified fluid storage container comprising a purified fluid inlet; and
a filter assembly according to claim 1 coupled with the contaminated fluid outlet and the purified fluid inlet.

54-56. (canceled)
